(19) United States
(12) Patent Application Publication
(10) Pub. No.: US 2021/0012063 A1
(43) Pub. Date: Jan. 14, 2021

(54) INFORMATION PROCESSING DEVICE, DISPLAY METHOD AND PROGRAM

(71) Applicant: Bank Invoice Corporation, Tokyo (JP)

(72) Inventor: Taro Teshima, Tokyo (JP)

(21) Appl. No.: 17/036,001

(22) Filed: Sep. 29, 2020

Related U.S. Application Data
(63) Continuation of application No. PCT/JP2018/013381, filed on Mar. 29, 2018.

(51) Int. Cl. G06F 40/186; G06Q 10/10; G06Q 30/04; G06Q 20/10

(52) U.S. Cl. CPC G06F 40/186; G06Q 20/102; G06Q 30/04; G06Q 10/107

(57) ABSTRACT

An invoice management apparatus includes an invoice data storage unit that stores therein, upon receipt of business document data including a template that is addressed to a specified recipient, from a terminal device over a network, the received business document data in association with the identification information of the recipient and issuer of the business document data, a template storage unit that stores therein a first template having prescribed items set therein, a second template having items different from the prescribed items, and identification information identifying a target that needs to use the second template, and a data processing unit that accesses, in displaying the business document data, the template storage unit, determines whether either the recipient or the issuer is the target, and upon determining that the recipient or the issuer is the target, applies the second template to the template included in the business document data.

### RELATED APPLICATIONS

This application claims priority under 35 U.S.C. § 120 to, and is a continuation of, co-pending International Application PCT/JP2018/013381, filed Mar. 29, 2018 and designating the US. This International application is incorporated by reference herein in its entirety.

### BACKGROUND

### Field

The embodiment discussed herein relates to an information processing apparatus and a display method.

There is known a technique that aims to manage viewing of business documents (for example, invoices and others) of a corporation and information thereof.

For example, there is known an information processing apparatus that includes a storage unit that stores therein plural types of structural document data, each in prescribed format including a plurality of item fields and item names corresponding to the item fields, and character data to be assigned to the item fields of the structural document data, and a management unit that stores, in the storage unit, the character data stored in the storage unit in association with the plurality of item fields and also stores, in the storage unit, a common item policy that defines rules to be applied to item fields common to plural types of structural document data among the plurality of item fields, in a master format having links to the character data to be assigned to the plurality of item fields.

Please see, for example, Japanese Laid-open Patent Publication No. 2017-174087.

For examples, a company may desire to include a specific item in invoices they will receive. In this case, the company may provide an invoice template to have the template filled out. However, if an update to the template is not done or a new person in charge does not notice the existence of the template, invoices based on the template are not issued.

### SUMMARY

According to one aspect, therein provided an information processing apparatus including: a first memory that stores therein, upon receipt of business document data including a template that is addressed to a specified recipient, from a terminal device over a network, the received business document data in association with identification information of the recipient and identification information of an issuer of the business document data; a second memory that stores therein a first template having prescribed items set therein, a second template having items different from the prescribed items, and identification information identifying a target that needs to use the second template; and a processor that is coupled to the first memory and the second memory and is configured to perform a process including accessing, in displaying the business document data, the second memory, determining whether either the recipient or the issuer is the target that needs to use the second template, and upon determining that the recipient or the issuer is the target that needs to use the second template, applying the second template to the business document data, wherein the process further includes applying the first template to the business document data upon determining that neither the recipient nor the issuer is the target that needs to use the second template, determining whether the first template has been customized, and upon determining that the first template has been customized, storing the customized first template as the second template in association with the identification information in the second memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an invoice management system according to a first embodiment.

FIG. 2 is a view for explaining an example of a screen that is displayed on a terminal device after a login.

FIG. 3 illustrates a hardware configuration of an invoice management apparatus according to the embodiment.

FIG. 4 is a block diagram illustrating functions of the invoice management apparatus according to the embodiment.

FIG. 5 is a view for explaining an example of invoice data.

FIG. 6 is a view for explaining information that is stored in a template storage unit.

FIG. 7 is a views for explaining information that is displayed in a summary display area.

FIGS. 8A and 8B are view for explaining information that is displayed in the summary display area.

FIG. 9 is a view for explaining an example of external communication data.

FIG. 10 is a view for explaining an example of attached file data.

FIG. 11 is a view for explaining an example of data stored in a history data storage unit.

FIG. 12 is a view for explaining an example of data stored in the history data storage unit.

FIG. 13 is views for explaining an example of memo data.

FIG. 14 is a view for explaining a management screen for drafting.

FIG. 15 is a view illustrating an invoice display area in which a template is open.

FIGS. 16A, 16B, and 16C are views for explaining an example of creation of a template.

FIG. 17 is a flowchart for explaining how a data processing unit operates.

### DETAILED DESCRIPTION

Hereinafter, an invoice management system according to one embodiment will be described in detail with reference to the accompanying drawings.

### First Embodiment

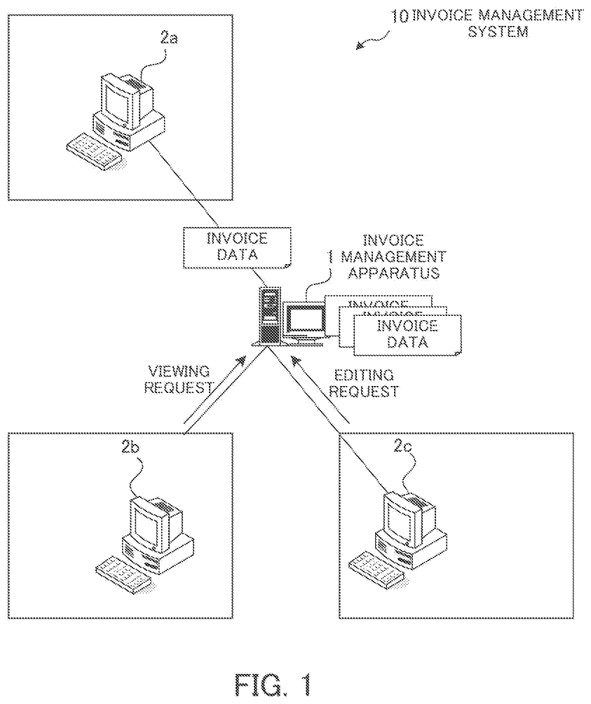

FIG. 1 illustrates an invoice management system according to a first embodiment.

In the invoice management system 10 of the first embodiment, an invoice management apparatus 1 is connected to terminal devices 2a, 2b, and 2c over the Internet or a dedicated network.

The terminal devices 2a, 2b, and 2c are placed at accounting departments of different companies. For example, the terminal device 2a is placed at a company A, the terminal device 2b is placed at a company B, and the terminal device 2c is placed at a company C. Examples of the terminal devices 2a, 2b, and 2c include desktop personal computers, laptop personal computers, tablet terminals, and smartphones.

A web program is installed in the invoice management apparatus 1 and the terminal devices 2a, 2b, and 2c. The terminal devices 2a, 2b, and 2c communicate invoice data on invoices with the invoice management apparatus 1 through Web browsers. In this connection, the present embodiment explains communication of invoice data, but invoices are an example of business documents and the embodiment is not limited thereto. Other examples of business documents include estimate forms and order forms.

Hereinafter, it is assumed that the invoice management system 10 is used by the individual accounting personnel of the companies A, B, and C.

Each accounting personnel of the companies A, B, and C performs user registration to the invoice management apparatus 1 using an assigned Email address or the like, in order to set up a connection to an invoice processing system provided by the invoice management apparatus 1.

After that, for example, the accounting personnel of the company A operates the terminal device 2a to display a login screen provided by the invoice management apparatus 1 on a monitor connected to the terminal device 2a. The accounting personnel enters his/her mail address and password on the login screen, thereby logging in to the service provided by the invoice management apparatus 1. In this connection, the mail address is an example of identification information identifying the accounting personnel.

After the login, the accounting personnel are able to operate their terminal devices 2a, 2b, and 2c to process invoice data, which is a digitized version of original invoices, via the invoice management apparatus 1. The processing of invoice data include creation, sending, receipt, viewing, editing, and others.

For example, when the accounting personnel of the company A issues an invoice to the company B, the accounting personnel of the company A operates the terminal device 2a to create the invoice with the company B designated as a bill-to party, on a management screen that is displayed after a login. Then, the accounting personnel sends the invoice data with the mail address of the accounting personnel (recipient) of the company B designated as a destination of the created invoice. The sent invoice data is held by the invoice management apparatus 1.

That is, the invoice data is not communicated directly between the terminal devices 2a, 2b, and 2c. Rather, all invoice data created by the terminal devices 2a, 2b, and 2c and sent to bill-to parties is held by the invoice management apparatus 1. The invoice data is treated like shared data. The invoice management apparatus 1 gives viewing and editing authorities for the invoice data to the terminal devices 2a, 2b, and 2c according to necessity.

The above approach makes it possible to digitize and process original invoices electronically, which leads to saving labor for management and storage of paper- or PDF-based invoices.

As described earlier, invoice data is not communicated directly between the terminal devices 2a, 2b, and 2c. In the following description, however, in the case where invoice data addressed to the mail address of the accounting personnel of the company B is sent from the accounting personnel of the company A, for example, an expression like “the accounting personnel receives the invoice data” may be used, as in the general communication of invoice data, for easy understanding.

In this connection, it is preferable that invoice data be communicated in an encrypted form between the invoice management apparatus 1 and each terminal device 2a, 2b, 2c.

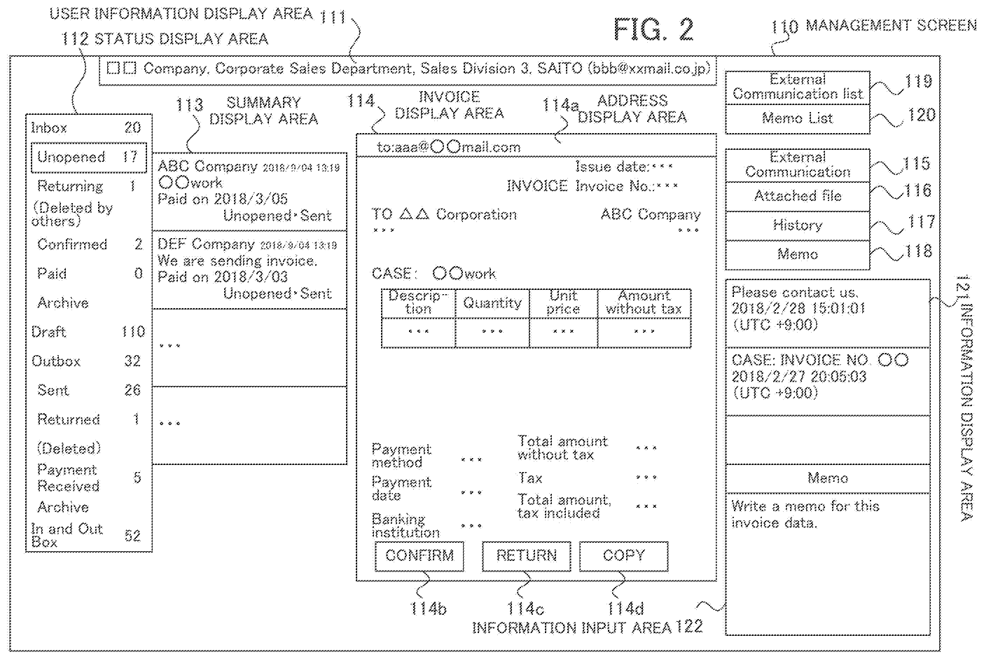

FIG. 2 is a view for explaining an example of a screen that is displayed on a terminal device after a login.

The management screen 110 illustrated in FIG. 2 is an example of a screen that is displayed on the terminal device 2a.

As illustrated in FIG. 2, an accounting personnel is able to create, issue, view, and edit invoice data, like he/she uses mail software.

By the way, in the above-described example, the accounting personnel of the company A is not able to rewrite invoice data once he/she sends it. In addition, the accounting personnel of the company B is also not able to rewrite the invoice data. If the invoice data contains an error, another version of the invoice data needs to be issued. In this connection, the old version of the invoice data is held by the invoice management apparatus 1, without being deleted, such as to be viewable at any time. To this end, the invoice management apparatus 1 performs version management of the invoice data, so as to easily search for a new version of the invoice data on the basis of an old version of the invoice data or for an old version of the invoice data on the basis of a new version of the invoice data.

The management screen 110 will be described in detail later.

Now, the disclosed invoice management system will be described more concretely.

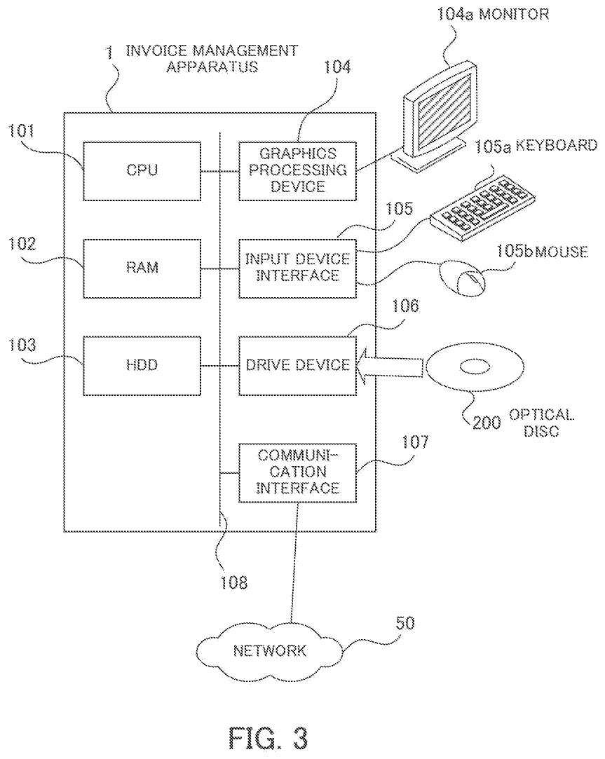

FIG. 3 illustrates a hardware configuration of the invoice management apparatus according to the present embodiment.

The invoice management apparatus 1 is entirely controlled by a CPU (central processing unit) 101. A RAM (random access memory) 102 and a plurality of peripheral devices are connected to the CPU 101 via a bus 108.

The RAM 102 is used as a main storage device of the invoice management apparatus 1. The RAM 102 temporarily stores therein at least part of an OS (operating system) program and an application program that are executed by the CPU 101. In addition, the RAM 102 stores therein various kinds of data to be used by the CPU 101 in processing.

Connected to the bus 108 are a HDD (hard disk drive) 103, a graphics processing device 104, an input device interface 105, a drive device 106, and a communication interface 107.

The HDD 103 magnetically writes and reads data on a built-in disk. The HDD 103 is used as an auxiliary storage device of the invoice management apparatus 1. An OS program, application programs, and various kinds of data are stored in the HDD 103. A semiconductor storage device, such as a flash memory, may be used as the auxiliary storage device.

The graphics processing device 104 is connected to a monitor 104a. The graphics processing device 104 displays images on a screen of the monitor 104a in accordance with instructions from the CPU 101. Examples of the monitor 104a include a display device using CRT (cathode ray tube) and a liquid crystal display.

The input device interface 105 is connected to a keyboard 105a and a mouse 105b. The input device interface 105 gives signals output from the keyboard 105a and mouse 105b to the CPU 101. The mouse 105b is an example of a pointing device, and another kind of pointing device may be used. Other examples of the pointing device include a touch panel, a tablet, a touchpad, and a trackball.

The drive device 106 reads data from, for example, a portable recording medium such as an optical disc, on which data is recorded so as to be readable with reflection of light, or a USB (universal serial bus) memory. For example, in the case where the drive device 106 is an optical drive device, data recorded on an optical disc 200 may be read with laser light or the like. Examples of the optical disc 200 include Blu-ray (registered trademark), DVD (digital versatile disc), DVD-RAM, CD-ROM (Compact Disc Read Only Memory), CD-R (Recordable), and CD-RW (ReWritable).

The communication interface 107 is connected to a network 50. The communication interface 107 communicates data with another computer or communication device over the network 50.

With the above hardware configuration, the processing functions of the present embodiment may be implemented. In this connection, FIG. 3 illustrates a hard configuration of the invoice management apparatus 1. The other computers including the terminal device 2a may be implemented with the same hardware configuration as the invoice management apparatus 1.

The invoice management apparatus 1 having the hardware configuration illustrated in FIG. 3 has the following functions.

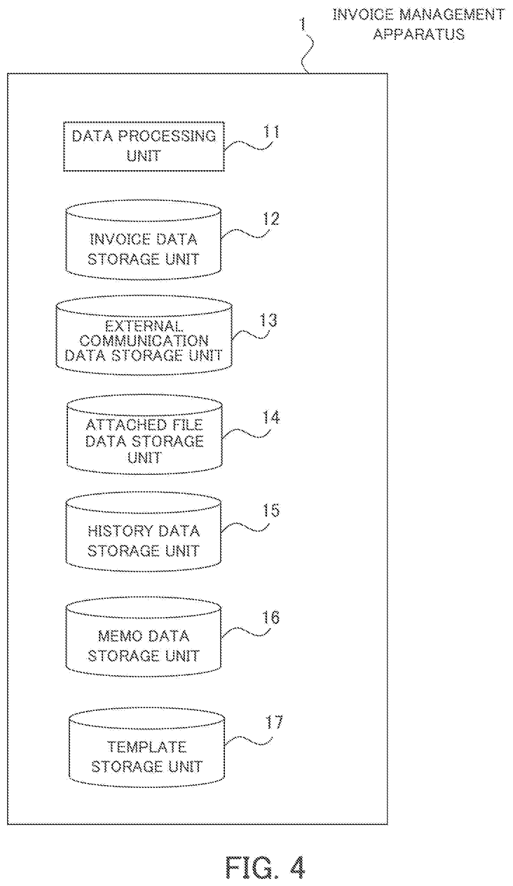

FIG. 4 is a block diagram illustrating functions of the invoice management apparatus according to the present embodiment.

The invoice management apparatus 1 has a data processing unit 11, an invoice data storage unit 12, an external communication data storage unit 13, an attached file data storage unit 14, a history data storage unit 15, a memo data storage unit 16, and a template storage unit 17.

The data processing unit 11 displays the management screen 110 illustrated in FIG. 2 on the terminal device 2a or the like in accordance with accounting personnel's operations. The data processing unit 11 performs appropriate processing according to operations made to invoice data on the management screen 110. For example, the data processing unit 11 classifies and stores invoice data received by the invoice management apparatus 1, external communications (to be described later) and memos made by an accounting personnel, and others in appropriate storage units.

In addition, the data processing unit 11 opens a first template (default template) having prescribed items set therein, in an invoice display area 114 illustrated in FIG. 2. In FIG. 2, Description, Quantity, Unit Price, and Amount without Tax are displayed as example items.

In addition, the data processing unit 11 stores, in the template storage unit 17, templates received by the invoice management apparatus 1 and templates created by the accounting personnel, for example. Hereinafter, these templates are referred to as “second templates.” These second templates are created using spreadsheet software such as Excel, for example. Then, the data processing unit 11 determines whether either the recipient or issuer of invoice data is a target that needs to use a second template, and if the recipient or issuer is a target that needs to use the second template, applies the second template to the template included in business document data. This process will be described later using an example.

The invoice data storage unit 12 stores therein invoice data received by the invoice management apparatus 1, by accounting personnel (more specifically, by mail address of accounting personnel). The invoice data received by the invoice management apparatus 1 includes invoice data sent from the accounting personnel of billers to the accounting personnel of bill-to parties and invoice data drafted by the accounting personnel (issuers) of the billers

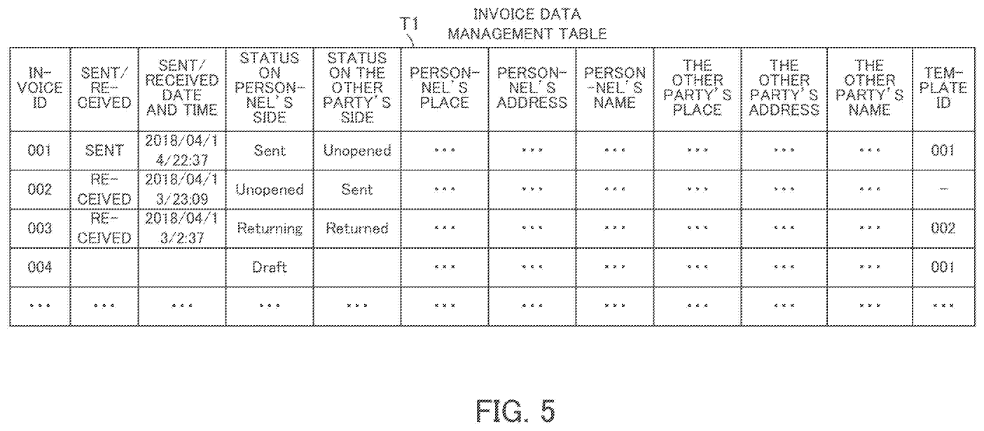

FIG. 5 is a view for explaining an example of invoice data.

In the present embodiment, data is stored in tabular form.

The invoice data management table T1 has the following columns: Invoice ID, Sent/Received, Sent/Received Date and Time, Status on Personnel's Side, Status on the Other Party's Side, Personnel's place, Personnel's Address, Personnel's Name, The Other Party's Place, The Other Party's Address, The Other Party's Name, and Template ID. Information pieces arranged in horizontal direction are associated with each other.

The Invoice ID column contains an ID unique to invoice data for use in management of invoice data. When the invoice management apparatus 1 receives invoice data, the data processing unit 11 gives an invoice ID to the invoice data.

The Sent/Received column indicates whether the invoice data is data that has been received or sent, in view of the accounting personnel. More specifically, “Received” indicates that the invoice data is received data, whereas “Sent” indicates the invoice data is sent data.

The Sent/Received Date and Time column contains the latest date and time among dates and times when the invoice data was sent and received.

The Status on Personnel's Side column contains the status (processing progress) of the invoice data in view of the accounting personnel.

The Status on the Other Party's Side column contains the status of the invoice data in view of the accounting personnel of the other party that communicates the invoice data.

The statuses to be set in the Status on Personnel's Side and Status on the Other Party's Side columns include the following: “Unopened,” “Returning,” “Deleted by the Other Party,” “Confirmed,” “Paid,” “Archive,” “Sent,” “Returned,” “Deleted,” and “Payment Received.” These statuses will be described in detail later.

The Personnel's Place column contains the names of the company and department to which the accounting personnel belongs.

The Personnel's Address column contains the mail address of the accounting personnel.

The Personnel's Name column contains the name of the accounting personnel.

The Other Party's Place column contains the names of the company and department to which the accounting personnel of the other party that communicates the invoice data belongs.

The Other Party's Address column contains the mail address of the accounting personnel of the other party that communicates the invoice data.

The Other Party's Name column contains the name of the other party that communicates the invoice data.

The Template ID column contains information identifying the type of a template stored in the template storage unit 17. The template ID may be the file name of the template, for example.

In addition to the illustrated information, the invoice data management table contains data on invoices, including the postal codes and addresses of both companies, breakdown items, and a billing amount.

The following describes information stored in the template storage unit 17.

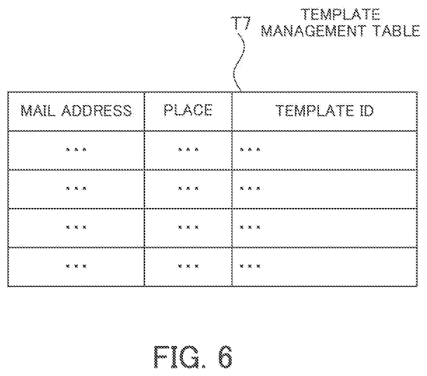

FIG. 6 is a view for explaining information that is stored in the template storage unit.

The template management table T7 has the following columns: Mail Address, Place, and Template ID. Information pieces arranged in horizontal direction are associated with each other. The mail address and place are examples of identification information identifying a target that needs to use a second template.

The Mail Address column contains the mail address of an accounting personnel or the mail address of the accounting personnel of the other party that communicates the invoice data.

The Place column contains the place of the accounting personnel corresponding to the mail address contained in the Mail Address column.

The template storage unit 17 also stores therein templates whose template IDs are set.

The following describes a management screen.

### Management Screen

The data processing unit 11 displays the management screen 110 illustrated in FIG. 2 on the terminal device 2a or the like in accordance with accounting personnel's operations.

The management screen 110 has a user information display area 111, a status display area 112, a summary display area 113, an invoice display area 114, an External Communication button 115, an Attached File button 116, a History button 117, a Memo button 118, an External Communication List display button 119, a Memo List display button 120, an information display area 121, and an information input area 122.

The user information display area 111 displays information (user information) on an accounting personnel that has logged in to the invoice management system. Referring to FIG. 2, the user information display area 111 displays the names of a company and department to which the accounting personnel belongs, and the surname and mail address of the accounting personnel.

The status display area 112 displays the number of pieces of invoice data that is handled by the accounting personnel that has logged in to the invoice management system, for each status.

Roughly, the status display area 112 includes the following folders: Inbox, Draft, Outbox, and In and Out Box.

The data processing unit 11 places invoice data with the mail address of the accounting personnel designated as a recipient, into the Inbox folder.

When the accounting personnel selects the Inbox folder, the data processing unit 11 refers to the invoice data management table T1. Then, the data processing unit 11 displays, in the summary display area 113, the summary of invoice data that has “Received” in the Sent/Received column, among invoice data that has “bbb@xxmail.co.jp” in the Personnel's Address column.

As illustrated in FIG. 2, invoice data placed in the Inbox folder has the following statuses: “Unopened,” “Returning,” “Deleted by the Other Party,” “Confirmed,” “Paid,” and “Archive.”

The “Unopened” status is given by the data processing unit 11 to invoice data that has not been confirmed by the accounting personnel among the invoice data placed in the Inbox folder.

The “Returning” status is given by the data processing unit 11 to invoice data that has been returned from the accounting personnel to the accounting personnel of the biller among the invoice data placed in the Inbox folder.

The “Deleted by the Other Party” status is given by the data processing unit 11 to invoice data that has been received, returned by the accounting personnel to the accounting personnel of the biller, and then deleted by the accounting personnel of the biller, among the invoice data placed in the Inbox folder.

The “Confirmed” status is given by the data processing unit 11 to invoice data which the accounting personnel has viewed and for which the accounting personnel has selected a Confirm button (to be described later), among the invoice data placed in the Inbox folder.

The “Paid” status is given by the data processing unit 11 to invoice data for which the accounting personnel has made payment and then selected a Payment button, among the invoice data placed in the Inbox folder.

The accounting personnel compiles the invoice data in the Paid status to confirm the details of the payment.

The “Archive” status is given by the data processing unit 11 to invoice data which the account personnel has saved in an archive at certain timing, among the invoice data in the “Paid” status.

A number displayed in association with each status in the status display area 112 indicates the number of pieces of invoice data in the status.

For example, the Unopened status in the status display area 112 indicates the number of pieces of invoice data that have not been confirmed by the accounting personnel among received invoice data.

In this connection, the Archive status in the status display area 112 does not specifically indicate any number.

When the accounting personnel would like to view the contents of invoice data in a desired one of the “Unopened,” “Retuning,” “Deleted by the Other Party,” “Confirmed,” “Paid,” and “Archive” statuses, he/she just selects the desired status in the status display area 112.

For example, when the accounting personnel selects the Unopened status, the data processing unit 11 refers to the invoice data management table T1. The data processing unit 11 then displays the summary of the invoice data having Unopened in the Status on Personnel's Side column among the invoice data having “bbb@xxmail.co.jp” in the Personnel's Address column, in the summary display area 113.

The data processing unit 11 places invoice data that has been created and saved by the accounting personnel but has not been sent to the accounting personnel of the recipient, in the Draft status.

The data processing unit 11 places invoice data that has been sent by the accounting personnel, into the Outbox folder.

When the accounting personnel selects the Outbox folder, the data processing unit 11 refers to the invoice data management table T1. The data processing unit 11 then displays the summary of the invoice data having “Sent” in the Sent/Received column among the invoice data having “bbb@xxmail.co.jp” in the Personnel's Address column, in the summary display area 113.

As illustrated in FIG. 2, invoice data placed in the Outbox folder has the following statuses: “Sent,” “Returned,” “Deleted,” “Payment Received,” and “Archive.”

The “Sent” status is given by the data processing unit 11 to invoice data for which the accounting personnel of the bill-to party has not made payment, among the invoice data placed in the Outbox folder.

The “Returned” status is given by the data processing unit 11 to invoice data that has been returned from the accounting personnel of the bill-to party, among the invoice data placed in the Outbox folder. The accounting personnel is able to process the invoice data returned from the bill-to party.

The “Deleted” status is given by the data processing unit 11 to invoice data that has been deleted by the accounting personnel of the biller, among the invoice data returned from the accounting personnel of the bill-to party.

The “Payment Received” status is given by the data processing unit 11 to invoice data for which the accounting personnel of the biller has confirmed payment and selected a Payment Received button, among the invoice data placed in the Outbox folder.

The “Archive” status is given by the data processing unit 11 to invoice data which the accounting personnel has saved in the Archive at certain timing, among the invoice data in the “Payment Received” status.

The Archive status in the status display area 112 does not specifically indicate any number.

What is needed to view the contents of invoice data in a desired one of the “Sent,” “Returned,” “Deleted,” “Payment Received,” and “Archive” statuses is just to select the desired status.

The summary display area 113 displays the summary of invoice data corresponding to a status selected by the accounting personnel in the status display area 112, as described earlier. The summary of received invoice data may include the company name of a biller, a case name, a payment date and time, a status on the sender side, and a status on the recipient side.

The same statuses are displayed on the management screens of both the accounting personnel who has sent invoice data and the accounting personnel who has received the invoice data.

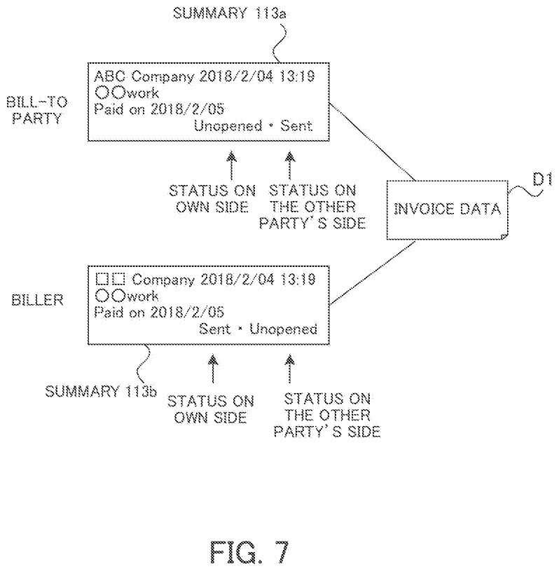

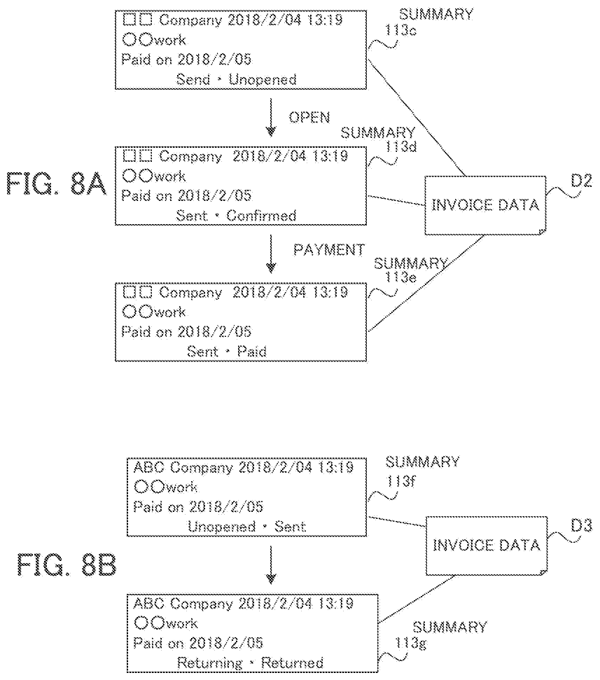

FIGS. 7, 8A and 8B are views for explaining information that is displayed in the summary display area.

FIG. 7 illustrates a summary 113a of invoice data that is displayed in the summary display area 113 of the management screen 110 viewed by the accounting personnel of the bill-to party, and a summary 113b that is displayed in the summary display area 113 of the management screen 110 viewed by the accounting personnel of the biller.

More specifically, invoice data D1 with a biller of ABC company and a case name of OO work, as illustrated in FIG. 7, is in the “Sent” status in the status display area on the management screen of the terminal device operated by the accounting personnel of the biller. When the accounting personnel of the biller selects the “Sent” status in the status display area, the following information is displayed with respect to the invoice data D1 in the summary display area 113: a bill-to party is [symbol] company, a case name is OO work, a status on the accounting personnel's side of the biller is “Sent,” and a status on the accounting personnel's side of the bill-to party is “Unopened.”

By confirming status transitions, the accounting personnel of the biller is able to easily confirm the progress of processing made by the accounting personnel of the bill-to party. That is to say, the accounting personnel of both parties are able to confirm the current status of each invoice data in real-time.

All summaries 113c, 113d, and 113e illustrated in FIG. 8A are of invoice data D2.

When the accounting personnel of the bill-to party has viewed the invoice data D2 and selected a Confirm button (to be described later), the data processing unit 11 changes information displayed in the summary display area 113 from the summary 113c to the summary 113d on the management screen 110 of the terminal device operated by the accounting personnel of the biller.

After that, when the accounting personnel of the bill-to party has made payment for the invoice data D2 and selected a Paid button, the data processing unit 11 changes information displayed in the summary display area 113 from the summary 113d to the summary 113e on the management screen 110 of the terminal device operated by the accounting personnel of the biller.

As another example, both summaries 113f and 113g illustrated in FIG. 8B are of invoice data D3.

When the accounting personnel of the bill-to party has viewed the invoice data D3 and selected a Return button (to be described later), the data processing unit 11 changes information displayed in the summary display area 113 from the summary 113f to the summary 113g on the management screen of the terminal device operated by the accounting personnel of the bill-to party.

Refer now back to FIG. 2.

When the accounting personnel has selected the summary of invoice data being displayed in the summary display area 113, the data processing unit 11 displays the contents of the invoice in the invoice display area 114. The contents of the invoice to be displayed in the invoice display area 114 are the same as those of existing (paper-based or PDF-based) invoices, except that an address display area 114a and various buttons, which will be described later, are displayed.

When the accounting personnel views invoice data placed in the Inbox folder, the data processing unit 11 displays the mail address of a sender accounting personnel (from) in the address display area 114a.

When the accounting personnel views invoice data placed in the Draft status or Outbox folder, the data processing unit 11 displays the mail address of a recipient accounting personnel (to).

In this connection, the data processing unit 11 may display the invoice ID of the invoice data in the invoice display area 114.

The accounting personnel is able to process an invoice being displayed in the invoice display area 114 on the management screen 110.

More specifically, buttons for processing the invoice are displayed in the invoice display area 114 according to the status of the invoice data.

FIG. 2 illustrates buttons that are displayed when invoice data in the Unopened status is selected.

The invoice display area 114 includes a Confirm button 114b, a Return button 114c, and a Copy button 114d.

When the accounting personnel selects the Confirm button 114b, the data processing unit 11 refers to the invoice data management table T1. The data processing unit 11 then changes the Status on Personnel's Side column to “confirmed” with respect to the invoice data being displayed in the invoice display area 114. In addition, the data processing unit 11 decreases the number for the “Unopened” status by one and increases the number for the “Confirmed” status by one in the status display area 112.

When the accounting personnel selects the Return button 114c, the data processing unit 11 refers to the invoice data management table T1. The data processing unit 11 then changes the Status on Personnel's Side column to “returning” with respect to the invoice data being displayed in the invoice display area 114, and then changes the Status on the Other Party's Side column to “returned”. In addition, the data processing unit 11 decreases the number for the “Unopened” status by one and increases the number for the “Returning” status by one in the status display area 112.

On the management screen of the accounting personnel who has received the returned invoice data, the number for the Returned status in the status display area is increased by one.

When the accounting personnel selects the Copy button 114d, the data processing unit 11 creates new invoice data by replacing the company name and address between the biller and the bill-to party in the invoice data. Then, the data processing unit 11 stores information on the created invoice data in the invoice data management table T1. At this time, with respect to the invoice data, “Draft” is set in the Status on Personnel's Side column and a blank is set in the Status on the Other Party's Side column.

Refer back to FIG. 2.

Among all invoice data placed in the Inbox and Outbox folders, data other than deleted invoice data, invoice data saved in the archive, and invoice data in the Draft status is placed in the In and Out Box folder.

### External Communication Button

When the accounting personnel selects the External Communication button 115, the data processing unit 11 switches the management screen 110 into an external communication input mode. In this external communication input mode, when the accounting personnel enters text (text data) in the information input area 122 and presses the enter key of a keyboard or the like to fix this operation, the data processing unit 11 stores, as an external communication, the text data in the external communication data storage unit 13 in association with the mail address of the accounting personnel and the invoice data being displayed in the invoice display area 114.

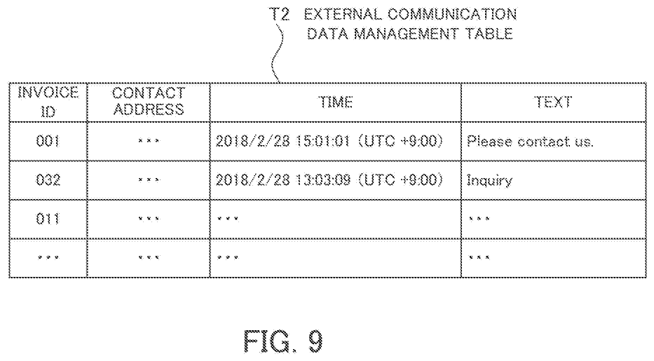

FIG. 9 is a view for explaining an example of external communication data.

In the present embodiment, external communication data is stored in tabular form.

The external communication data management table T2 has the following columns: Invoice ID, Contact Address, Time, and Text. Information pieces arranged in a horizontal direction are associated with each other.

The Invoice ID column contains the invoice ID of invoice data (invoice data associated with external communication data) that was displayed in the invoice display area 114 when the accounting personnel created the external communication data.

The Contact Address column contains the mail address of a creator that has created the external communication data.

The Time column contains the creation date and time of the external communication data.

The Text column contains the contents of the external communication.

In addition, in the external communication input mode, the data processing unit 11 refers to the external communication data management table T2 with respect to the invoice data being displayed in the invoice display area 114, and displays the external communications created so far, together with the fixed dates and times in chronological order in the information display area 121.

The information display area 121 displays external communications entered by the accounting personnel of both the sender and the recipient of the invoice data. Therefore, this external communication input mode enables these accounting personnel to perform communications like chats with each other.

In this connection, other processing (downloading, conversion to PDF format, and others) performed by the accounting personnel on the invoice data being displayed in the invoice data display area 114 may be indicated in the information display area 121 together with the execution dates and times of the processing. This enables both the accounting personnel to know the history on each other's processing.

(Attached File Button)

When the accounting personnel selects the Attached File button 116, the data processing unit 11 switches the management screen 110 into an attached file mode. In this attached file mode, when the accounting personnel clicks and drags attached data into the information input area 112 and presses the enter key of the keyboard or the like to fix this operation, the data processing unit 11 stores the attached data in the attached file data storage unit 14 in association with the mail address of the accounting personnel and the invoice data being displayed in the invoice display area 114.

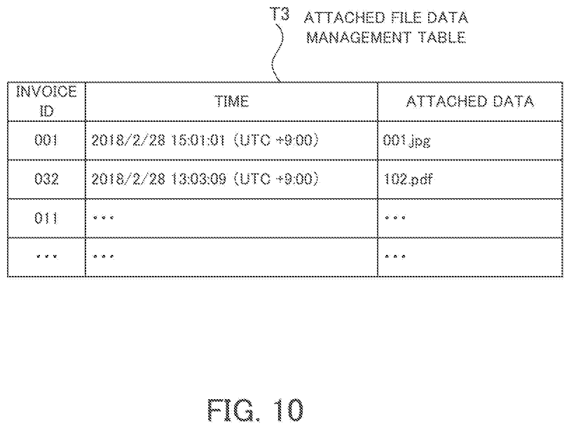

FIG. 10 is a view for explaining an example of attached file data.

In the present embodiment, attached file data is stored in tabular form.

The attached file data management table T3 has the following columns: Invoice ID, Time, and Attached Data. Information pieces arranged in a horizontal direction are associated with each other.

The Invoice ID column contains the invoice ID of invoice data (invoice data associated with attached data) that was displayed on a screen when the attached data was attached.

The Time column contains the attached date and time of the attached data.

The Attached Data column contains the name of the attached data.

In a file mode, the data processing unit 11 refers to the attached file data management table T3 with respect to invoice data being displayed in the invoice display area 114, and displays information about attached files attached so far, in chronological order in the information display area 121.

### History Button

The data processing unit 11 stores a history on operations made so far by the accounting personnel of both parties in the history data storage unit 15.

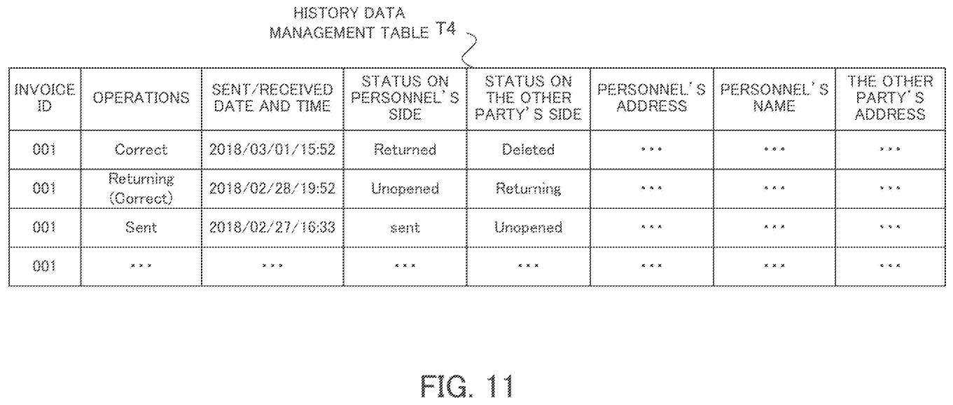

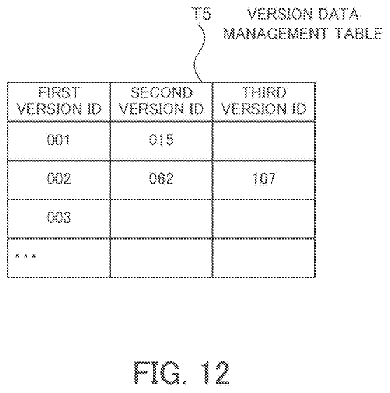

FIGS. 11 and 12 are views for explaining an example of data stored in the history data storage unit.

In the present embodiment, data is stored in tabular form.

The data processing unit 11 creates a history data management table T4 for each invoice data. In this connection, a different history data management table T4 is created for a different version.

The history data management table T4 has the following columns: Invoice ID, Operations, Send/Received Date and Time, Status on Personnel's Side, Status on the Other Party's Side, Personnel's Address, Personnel's Name, and The Other Party's Address. Information pieces arranged in a horizontal direction are associated with each other.

The Operations column contains an operation made by the accounting personnel. The other columns have the same contents as those of the invoice data management table T1, and therefore the description of these columns will not be repeated.

As illustrated in FIG. 12, a version data management table T5 has the following columns: First Version ID, Second Version ID, and Third Version ID. Information pieces arranged in a horizontal direction are associated with each other.

The First Version ID column contains an invoice ID that was given by the data processing unit 11 when the accounting personnel created invoice data and selected a Save button (not illustrated) on the management screen 110.

The Second Version ID column contains an invoice ID that was given by the data processing unit 11 when the accounting personnel created a second version based on the invoice data with the first version ID and selected the Save button (not illustrated) on the management screen 110.

The Third Version ID column contains an invoice ID that was given by the data processing unit 11 when the accounting personnel created a third version based on the invoice data with the second version ID and selected the Save button (not illustrated) on the management screen 110.

FIG. 12 illustrates columns up to the third version. If a fourth version of the invoice data is created, the data processing unit 11 adds an invoice ID of the created invoice data to a column of the version data management table T5. The same operation is performed for the fifth and subsequent versions.

When the accounting personnel selects the History button 117, the data processing unit 11 switches the management screen 110 to a history display mode. More specifically, the data processing unit 11 refers to the history data management table T4 and the version data management table T5, and displays a history about transactions of the invoice data being displayed in the invoice display area 114, in chronological order in the information display area 121.

### Memo Button

When the accounting personnel selects the Memo button 118, the data processing unit 11 switches the management screen 110 into a memo input mode. In this memo input mode, when the accounting personnel enters letters and so on in the information input area 122 and presses the enter key of the keyboard or the like to fix this operation, the data processing unit 11 stores the letters and so on as a memo in association with the mail address of the accounting personnel and the invoice data being displayed in the invoice display area 114 in the memo data storage unit 16. This memo is viewable only by the person who created the memo.

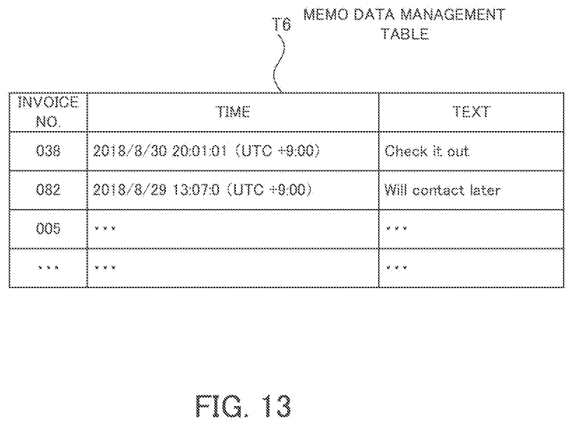

FIG. 13 is a view for explaining an example of memo data.

In the present embodiment, memo data is stored in tabular form.

The memo data management table T6 has the following columns: Invoice ID, Time, and Text. Information pieces arranged in a horizontal direction are associated with each other.

The Invoice ID column contains the invoice ID of invoice data (invoice data associated with a memo) that was displayed on a screen when the accounting personnel created the memo.

The Time column contains the creation date and time of the memo data.

The Text column contains the contents of the memo.

In addition, in the memo input mode, the data processing unit 11 accesses the memo data storage unit 16 to display memos created so far about invoice data being displayed in the invoice display area 114 in chronological order in the information display area 121.

Refer now back to FIG. 2 again.

### External Communication List Display Button

When the accounting personnel selects the External Communication List display button 119, the data processing unit 11 accesses the external communication data storage unit 13 storing therein data about external communications, and displays a list screen (external communication list screen) regarding external communications about invoices handled by the accounting personnel in chronological order on the management screen 110.

### Memo List Display Button

When the accounting personnel selects the Memo List display button 120, the data processing unit 11 accesses the memo data storage unit 16 storing therein data on external communications, to display a list screen (memo list screen) of memos regarding invoices handled by the accounting personnel in chronological order on the management screen 110.

The following describes a customization screen for an invoice template.

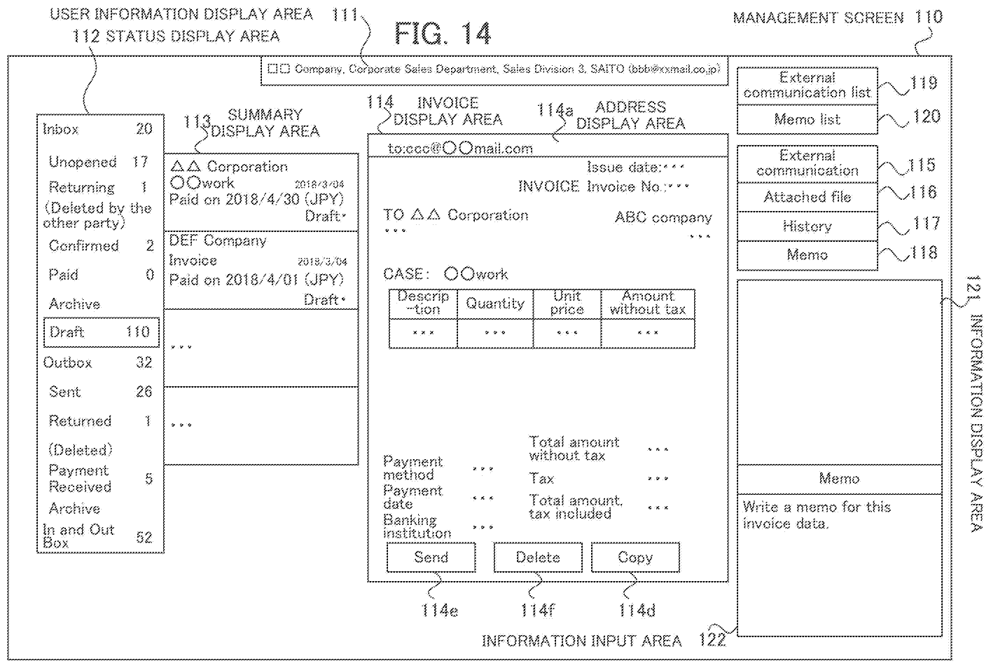

FIG. 14 is a view for explaining a management screen for drafting.

FIG. 14 describes a case where Saito who is a sender accounting personnel sends an invoice to Teshima who is a destination accounting personnel at [symbol] corporation.

FIG. 14 illustrates buttons that are displayed when an invoice is drafted.

The invoice display area 114 has a Send button 114e, a Delete button 114f, and a Copy button 114d.

When the accounting personnel selects the Send button 114e, the data processing unit 11 refers to the invoice data management table T1. Then, the data processing unit 11 changes the Status on Personnel's Side column to “Sent” with respect to the invoice data being displayed in the invoice display area 114. In addition, the data processing unit 11 decreases the number for the “Draft” status by one and increases the number for the “Sent” status by one in the status display area 112.

When the accounting personnel selects the Delete button 114f, the data processing unit 11 refers to the invoice data management table T1. Then, the data processing unit 11 deletes a record regarding the invoice. In addition, the data processing unit 11 decreases the number for the “Draft” status by one in the status display area 112.

When “drafting” an invoice, Saito selects “ccc@oomail.com” that is Teshima's mail address (the other party's mail address) from a pull-down menu or directly enters this mail address in the address display area 114a.

At this time, the data processing unit 11 refers to the template management table T7 and determines whether there is any template associated with Teshima's mail address being displayed in the address display area 114a.

If there is no template associated with Teshima's mail address, the data processing unit 11 opens a first template having prescribed items set therein, in the invoice display area 114.

If there is a second template associated with Teshima's mail address, the data processing unit 11 opens (displays) the associated second template in the invoice display area 114.

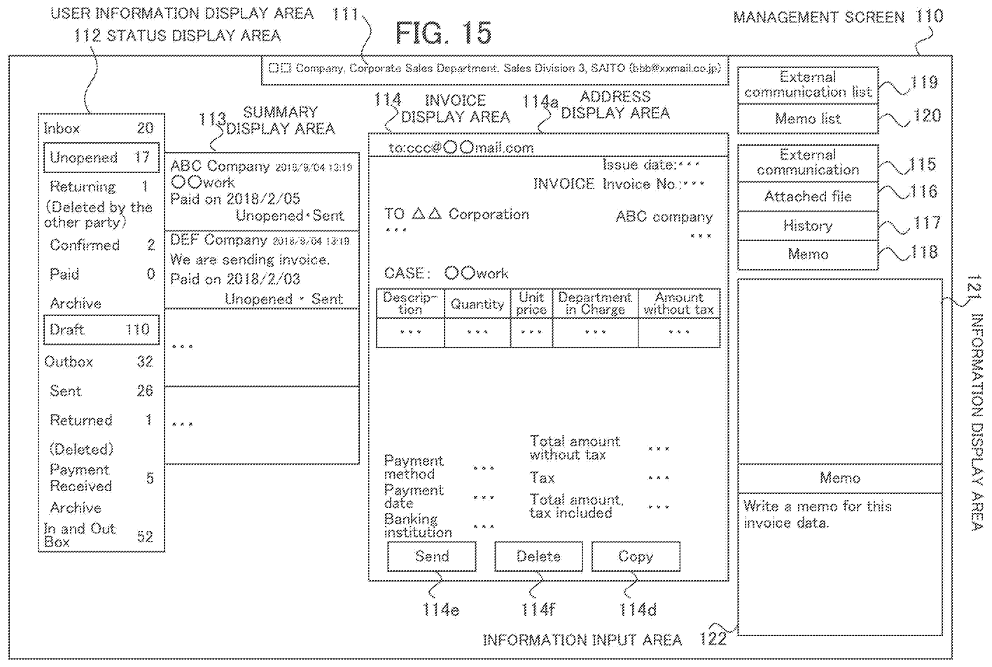

FIG. 15 illustrates an invoice display area in which the second template is open.

As an example, the invoice display area 114 of FIG. 15 displays a second template that additionally includes “Department in Charge.” This embodiment employs a mechanism that does not allow this invoice to be sent without anything written in this “Department in Charge” (for example, a transmission error is displayed or the Send button 114e is invalid).

In this connection, this embodiment has described the case where the second template is opened when a mail address is entered. Another trigger to open the second template may be that, when the destination (company name, department name) of the invoice is entered, the second template may be opened on the basis of the destination.

Further, in the embodiment, the second template is opened on the basis of a mail address. The embodiment is not limited thereto and the second template may be opened on the basis of a domain.

Still further, for example, Saito may be able to newly create a second template when issuing an invoice.

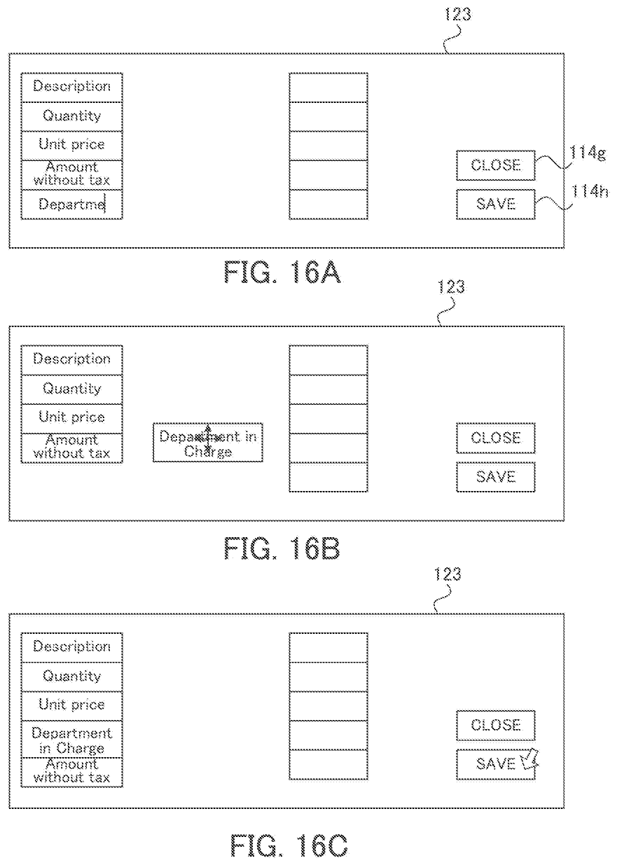

FIGS. 16A, 16B, and 16C are views for explaining an example of creating a second template.

FIG. 16A illustrates a creation screen 123 that is displayed on a monitor when a second template is created.

The creation screen 123 includes Description, Quantity, Unit Price, and Amount without Tax as the items of the first template. The creation screen 123 also has a Close button 114g and a Save button 114h. When the Close button 114g is selected, the data processing unit 11 closes the creation screen 123. When the Save button 114h is selected, the data processing unit 11 saves the data created on the creation screen 123.

When Saito desires to newly add a department in charge, Saito directly enters the characters to be added.

FIG. 16B illustrates an operation to place the entered “Department in Charger” before the “Amount without Tax.” Saito inserts the “Department in Charge” between the “Unit Price” and “Amount without Tax” via drag-and-drop. This allows the “Department in Charge” to be displayed before the “Amount without Tax” as illustrated in FIG. 16C. When the Save button 114g is selected in this state, this template is saved as a second template.

In addition, for example, when a cost is incurred for communication of invoice data, different cost systems may be applied for invoice data using the second template and invoice data using the first template.

The following describes how the data processing unit 11 operates, with reference to a flowchart.

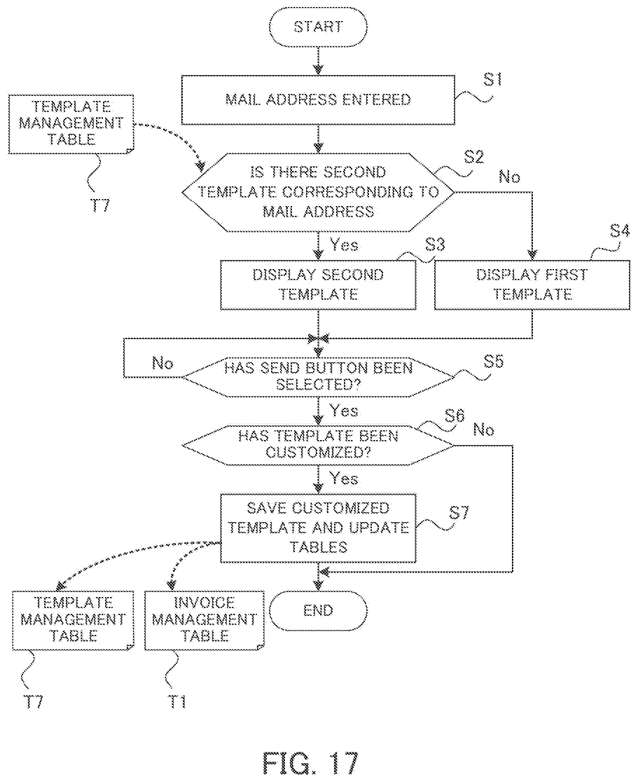

FIG. 17 is a flowchart for explaining how the data processing unit operates.

Step S1. The data processing unit 11 receives a notice that an accounting personnel has entered the other party's mail address in the address display area 114a.

Step S2. The data processing unit 11 refers to the template management table T7 to determine whether there is a second template corresponding to the mail address entered at step S1. If such a second template is found (Yes at step S2), the process proceeds to step S3. If such a second template is not found (No at step S2), the process proceeds to step S4.

Step S3. The data processing unit 11 opens the second template in the invoice display area 114.

Step S4. The data processing unit 11 opens a first template in the invoice display area 114.

Step S5. The data processing unit 11 waits for selection of the Send button 114e. When the Send button 114e is selected, the process proceeds to step S6.

Step S6. The data processing unit 11 determines whether the template has been customized. If the template has been customized (Yes at step S6), the process proceeds to step S7. If the template has not been customized (No at step S6), the process of FIG. 17 is completed.

Step S7. The data processing unit 11 stores the customized template as a second template, and creates and assigns a new template ID. The data processing unit 11 registers the other party's mail address entered in the address display area 114a, the other party's place, and template ID in association with each other in the template management table T7.

In addition, with reference to The Other Party's Address column of the invoice data management table T1, the data processing unit 11 sets the assigned template ID in the Template ID column with respect to the invoice data associated with the mail address matching the other party's mail address entered in the address display area 114a in the invoice data management table T1. Then, the process of FIG. 17 is completed.

As described above, in the invoice management system 10, the invoice management apparatus 1 includes the invoice data storage unit 12 that stores therein, upon receipt of invoice data including a template that is addressed to a specified recipient, from a terminal device over a network 50, the received invoice data in association with the identification information of the recipient and the identification information of the issuer of the invoice data, the template storage unit 17 that stores therein a first template having prescribed items set therein, a second template having items different from these items, and identification information identifying a target that needs to use the second template, and the data processing unit 11 that accesses the template storage unit 17 when displaying the invoice data, determines whether either the recipient or issuer needs to use the second template, and if either one is the target that needs to use the second template, applies the second template to the invoice data. With this approach, a sender is able to enter various information (department in charge, account titles, and others) that is requested by a recipient, on one screen and send it. This allows the recipient to receive the invoice that additionally includes the information requested by the recipient. As a result, the recipient is able to view various information appended to the invoice sent from the sender. In addition, a CSV output may be generated in the same format.

Note that invoice data is not communicated directly between the terminal devices 2a, 2b, and 2c. The invoice data created using the terminal devices 2a, 2b, and 2c and sent to bill-to parties is held by the invoice management apparatus 1 and is treated like shared data. Therefore, the accounting personnel of a bill-to party is able to obtain an original invoice by printing out the invoice data.

In addition, electronic signature processing, timestamp processing, and other processing are not needed, thereby making it possible to save labor for converting paper-based invoices to PDF files for tax inquiry.

The information display area 121 displays external communications made by the accounting personnel of both the sender and the recipient of invoice data. Therefore, using the external communication input mode enables the accounting personnel of both parties to perform communications like chats.

Information on invoice data is stored in the invoice data management table T1 when the invoice data is sent, and the statuses of subsequent transactions are managed using this invoice data management table T1. Therefore, the accounting personnel is able to get away from manually compiling invoices into a data sheet.

Note that the processing performed by the invoice management apparatus 1 may be performed in a distributed manner by a plurality of apparatuses.

In addition, in the embodiment, the invoice management apparatus 1 is provided with various storage units including the invoice data storage unit 12. The embodiment is not limited thereto, and cloud storage may be provided, instead of the various storage units, at a location different from the data processing unit 11.

Heretofore, the information processing apparatus and display method of the present invention have been described in the embodiment illustrated. The invention is not limited thereto, and the components of each unit may be replaced with other components having equivalent functions or other components. In addition, other desired configurations and steps may be added.

Further, two or more desired configurations (features) in the above-described embodiment may be combined.

The above-described processing functions may be implemented by using a computer. In this case, a program is prepared, which describes processes for the functions of the invoice management apparatus 1. A computer implements the above-described processing functions by executing the program. The program describing the intended processes may be recorded on a computer-readable recording medium. Computer-readable recording media include magnetic storage devices, optical discs, magneto-optical recording media, semiconductor memories, etc. The magnetic storage devices include HDDs, Flexible Disks (FD), Magnetic Tapes, etc. The optical discs include DVDs, DVD-RAMs, CD-ROMs, CD-RWs, etc. The magneto-optical recording media include MOs (Magneto-Optical disk), etc.

To distribute the program, portable recording media, such as DVDs and CD-ROMs, on which the program is recorded, may be put on sale. Alternatively, the program may be stored in the storage device of a server computer and may be transferred from the server computer to other computers over a network.

A computer which is to execute the above program stores in its local storage device the program recorded on a portable recording medium or transferred from the server computer, for example. Then, the computer reads the program from the local storage device, and runs the program. The computer may run the program directly from the portable recording medium. Also, while receiving the program being transferred from the server computer, the computer may sequentially run this program.

In addition, the above-described processing functions may also be implemented wholly or partly by using DSP (digital signal processor), ASIC (application-specific integrated circuit), PLD (programmable logic device), or other electronic circuits.

According to one aspect, it is possible to create a business document in requested format easily and without fail.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An information processing apparatus comprising:
a first memory that stores therein, upon receipt of business document data including a template that is addressed to a specified recipient, from a terminal device over a network, the received business document data in association with identification information of the recipient and identification information of an issuer of the business document data;
a second memory that stores therein a first template having prescribed items set therein, a second template having items different from the prescribed items, and identification information identifying a target that needs to use the second template; and
a processor that is coupled to the first memory and the second memory and is configured to perform a process including
accessing, in displaying the business document data, the second memory, determining whether either the recipient or the issuer is the target that needs to use the second template, and upon determining that the recipient or the issuer is the target that needs to use the second template, applying the second template to the business document data,
wherein the process further includes
applying the first template to the business document data upon determining that neither the recipient nor the issuer is the target that needs to use the second template, determining whether the first template has been customized, and upon determining that the first template has been customized, storing the customized first template as the second template in association with the identification information in the second memory.

2. The information processing apparatus according to claim 1, wherein the identification information identifying the target that needs to use the second template includes at least one of a mail address or a place.

3. A display method comprising:
in accessing a first memory and displaying business document data including a template, the first memory being configured to store therein, upon receipt of the business document data that is addressed to a specified recipient, from a terminal device over a network, the received business document data in association with identification information of the recipient and identification information of an issuer of the business document data,
accessing, by a computer, a second memory that stores therein a first template having prescribed items set therein, a second template having items different from the prescribed items, and identification information identifying a target that needs to use the second template;
determining, by the computer, whether either the recipient or the issuer is the target that needs to use the second template;
applying, by the computer, the second template to the business document data upon determining that the recipient or the issuer is the target that needs to use the second template; and
applying, by the computer, the first template to the business document data upon determining that neither the recipient nor the issuer is the target that needs to use the second template, determining whether the first template has been customized, and upon determining that the first template has been customized, storing the customized first template as the second template in association with the identification information in the second memory.

4. A non-transitory computer-readable storage medium storing a computer program that causes a computer to perform a process comprising:
in accessing a first memory and displaying business document data including a template, the first memory being configured to store therein, upon receipt of the business document data that is addressed to a specified recipient, from a terminal device over a network, the received business document data in association with identification information of the recipient and identification information of an issuer of the business document data,
accessing a second memory that stores therein a first template having prescribed items set therein, a second template having items different from the prescribed items, and identification information identifying a target that needs to use the second template;
determining whether either the recipient or the issuer is the target that needs to use the second template;
applying the second template to the business document data upon determining that the recipient or the issuer is the target that needs to use the second template; and
applying the first template to the business document data upon determining that neither the recipient nor the issuer is the target that needs to use the second template, determining whether the first template has been customized, and upon determining that the first template has been customized, storing the customized first template as the second template in association with the identification information in the second memory.
